(19) United States
(12) Patent Application Publication
(10) Pub. No.: US 2016/0012354 A1
(43) Pub. Date: Jan. 14, 2016

(54) INFORMATION PROCESSING DEVICE, INFORMATION PROCESSING METHOD, AND INFORMATION PROCESSING PROGRAM

(71) Applicant: Rakuten, Inc., Shinagawa-ku, Tokyo (JP)

(72) Inventor: Takaaki KOSHINUMA, Tokyo (JP)

(73) Assignee: Rakuten, Inc., Tokyo (JP)

(21) Appl. No.: 14/771,075

(22) PCT Filed: Feb. 28, 2013
(86) PCT No.: PCT/JP2013/055485

§ 371 Date: Aug. 27, 2015

(51) Int. Cl. G06Q 10/02

(52) U.S. Cl. CPC G06Q 10/02

(57) ABSTRACT

An information processing device according to one embodiment includes an acquisition unit, an estimation unit, and a transmitting unit. The acquisition unit acquires, in response to an information provision request from a user terminal to an information providing means that provides facility information, the number of accesses to a facility since a specified period before receipt of the information provision request. The estimation unit estimates whether a facility can accept reservations based on seating capacity of the facility and the number of accesses to the facility. The transmitting unit outputs information based on an estimation result by the estimation unit to the user terminal.

### TECHNICAL FIELD

One aspect of the present invention relates to an information processing device, an information processing method, and an information processing program for supporting facility reservation of users.

### BACKGROUND ART

An Internet reservation system that allows reservations for seats of bullet trains, airplanes and the like through a network such as the Internet is known. Further, a system that, in response to a search request from a user terminal, transmits vacant seat information of a facility to the user terminal is known. For example, Patent Literature 1 below describes a vacancy information providing system where users can view time-limited vacancy information of facilities and thereby easily find and make reservations of facilities with vacancy information. This system includes a vacancy information receiving means that, when receiving vacancy information from a facility terminal, records the vacancy information and a record time of the vacancy information into a facility database, and when receiving only a request for recording of vacancy information from a facility terminal, records a record time of vacancy information and predetermined vacancy information into the facility database, and a vacancy information providing means that extracts and transmits information about facilities that match conditions received from a user terminal, vacancy information, and a record time of vacancy information.

### CITATION LIST

### Patent Literature

Patent Literature 1: JP 2003-76902 A

### SUMMARY OF INVENTION

### Technical Problem

However, in the technique according to related art such as the vacancy information providing system described above, it is necessary for facilities to constantly record or update availability of facilities, which imposes a heavy burden on facilities, unlike the Internet reservation system that allows reservations for seats. Thus, a framework capable of receiving reservations for facilities from users while reducing a burden on facilities that manage vacancies is desired.

### Solution to Problem

An information processing device according to one aspect of the present invention includes an acquisition unit configured to, in response to an information provision request from a user terminal to an information providing means that provides facility information, acquire the number of accesses to a facility since a specified period before receipt of the information provision request, an estimation unit configured to estimate whether a facility can accept reservations based on seating capacity of the facility and the number of accesses to the facility, and a transmitting unit configured to output information based on an estimation result by the estimation unit to the user terminal.

An information processing method according to one aspect of the present invention includes an acquisition step of, in response to an information provision request from a user terminal to an information providing means that provides facility information, acquiring the number of accesses to a facility since a specified period before receipt of the information provision request, an estimation step of estimating whether a facility can accept reservations based on seating capacity of the facility and the number of accesses to the facility, and a transmitting step of outputting information based on an estimation result in the estimation step to the user terminal.

An information processing program according to one aspect of the present invention causes a computer to implement an acquisition unit configured to, in response to an information provision request from a user terminal to an information providing means that provides facility information, acquire the number of accesses to a facility since a specified period before receipt of the information provision request, an estimation unit configured to estimate whether a facility can accept reservations based on seating capacity of the facility and the number of accesses to the facility, and a transmitting unit configured to output information based on an estimation result by the estimation unit to the user terminal.

According to the above aspects, whether a facility can accept reservations or not is estimated from the capacity of the facility and the number of accesses to the facility, and information based on the estimation result is provided to a user. In this manner, by estimating the availability of facilities from the number of accesses to facilities, it is possible to save each facility time and effort to record or update its availability by themselves It is thereby possible to receive reservations for facilities from users while reducing a burden on facilities that manage vacancies.

In the information processing device according to another aspect, the acquisition unit may acquire a total number of people for reservations made between a facility and users, and the estimation unit may calculate the number of vacant seats of the facility from the seating capacity and the total number multiplied by a specified coefficient larger than 1, and estimate a facility where the number of vacant seats is equal to or larger than a specified threshold as a facility able to accept reservations.

In the information processing device according to another aspect, the acquisition unit may acquire an access rate by dividing the number of accesses to a facility page by the seating capacity, and the estimation unit may estimate a facility where the access rate is equal to or lower than a specified threshold as a facility able to accept reservations.

In the information processing device according to another aspect, when the acquisition unit can acquire the total number, the estimation unit may calculate the number of vacant seats and estimate a facility where the number of vacant seats is equal to or larger than a specified threshold as a facility able to accept reservations, and when the acquisition unit cannot acquire the total number, the acquisition unit may acquire an access rate by dividing the number of accesses to a facility page by the seating capacity, and the estimation unit may estimate a facility where the access rate is equal to or lower than a specified threshold as a facility able to accept reservations.

The information processing device according to another aspect may further include an instruction unit configured to instruct the acquisition unit and the estimation unit to perform processing when it is determined to provide information based on the estimation result to an applicant based on an access history related to the applicant.

In the information processing device according to another aspect, the access history may contain a viewing history being records of viewing of facility pages by users, and the instruction unit may instruct the acquisition unit and the estimation unit to perform processing when it is determined based on the viewing history that the applicant has accessed a plurality of facility pages within a specified period of time.

In the information processing device according to another aspect, the access history may contain a communication history being records of communication between users and facilities, and the instruction unit may instruct the acquisition unit and the estimation unit to perform processing when it is determined based on the communication history that the applicant has received a reservation unaccepted notice from a plurality of facilities within a specified period of time.

In the information processing device according to another aspect, the communication history may be an email history being records of emails between users and facilities, and the instruction unit may analyze content of each email and thereby determine whether the email corresponds to the reservation unaccepted notice.

In the information processing device according to another aspect, the communication history may be a call history being records of calls between users and facilities, and the instruction unit may determine that the applicant has received a reservation unaccepted notice from a plurality of facilities when it is specified based on the communication history that the applicant has called the plurality of facilities within a specified period of time.

In the information processing device according to another aspect, when the number of facilities able to accept reservations obtained by estimation processing is equal to or less than a specified number, the estimation unit may perform another estimation processing with a less strict condition than the estimation processing.

In the information processing device according to another aspect, the communication history may be a call history being records of calls between users and facilities, and the instruction unit may determine that the applicant has received a reservation unaccepted notice from a plurality of facilities when it is specified based on the communication history that the applicant has called the plurality of facilities within a specified period of time.

### Advantageous Effects of Invention

According to one aspect of the preset invention, it is possible to receive reservations for facilities from users while reducing a burden on facilities that manage vacancies.

### BRIEF DESCRIPTION OF DRAWINGS

FIG. 1 is a view showing the overall configuration of a reservation system according to an embodiment.

FIG. 2 is a view showing an example of a web page of a restaurant search site.

FIG. 3 is a view showing an example of a web page of a restaurant search site.

FIG. 4 is a view showing the concept of presentation of vacancy information according to the embodiment

FIG. 5 is a view showing an example of restaurant information.

FIG. 6 is a view showing an example of an access history (reservation history).

FIG. 7 is a view showing an example of an access history (viewing history).

FIG. 8 is a view showing an example of an access history (search history).

FIG. 9 is a view showing an example of an access history (email history)

FIG. 10 is a view showing an example of an access history (call history).

FIG. 11 is a view showing an example of user information.

FIG. 12 is a view showing the hardware configurations of a reservation server according to the embodiment.

FIG. 13 is a block diagram showing the functional configurations of the reservation server according to the embodiment.

FIG. 14 is a sequence chart showing the operation of the reservation system according to the embodiment.

FIG. 15 is a view showing the configuration of an information processing program according to the embodiment.

### DESCRIPTION OF EMBODIMENTS

An embodiment of the present invention is described hereinafter in detail with reference to the appended drawings. Note that, in the description of the drawings, the same or equivalent elements are denoted by the same reference symbols, and the redundant explanation thereof is omitted. In the following embodiment, an information processing device according to the present invention is applied to a reservation server.

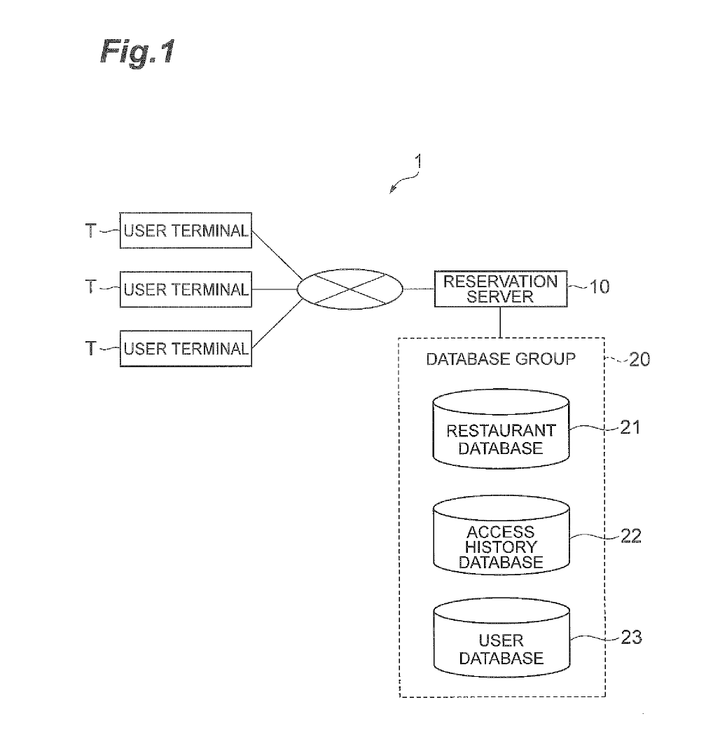

The functions and configuration of a reservation system 1 according to an embodiment are described hereinafter with reference to FIGS. 1 to 13. The reservation system 1 is a computer system that performs processing for reservations for use of facilities. For example, the reservation system 1 presents facilities that match a search query, presents availability of facility use, or receives reservations for facility use in response to a request (information provision request) from user terminals. With use of this reservation system 1, users can find desired facilities and make reservations for the facilities. The feature of the reservation system 1 is to provide users with facilities that have vacancies and can accept reservations, and this feature is particularly described hereinbelow.

Although this embodiment is based on the assumption that the reservation system 1 receives reservations for restaurants, the present invention is applicable to a system that manages reservations for facilities other than restaurants. For example, the present invention may be applied to management of reservations for various facilities such as stadiums, concert halls, movie theaters, theaters and hotels.

As shown in FIG. 1, the reservation system 1 includes user terminals T, a reservation server (information processing device) 10, and a database group 20. The user terminals T and the reservation server 10 are connected through a network such as the Internet. The reservation server 10 can access the database group 20 through a network such as the Internet or a private line. Although three user terminals T are shown in FIG. 1, the number of user terminals T is not particularly limited.

The type of the user terminals T is not particularly limited, and it may be a stationary or portable personal computer, or a mobile terminal such as an advanced mobile phone (smart phone), a cellular phone or a personal digital assistant (PDA), for example.

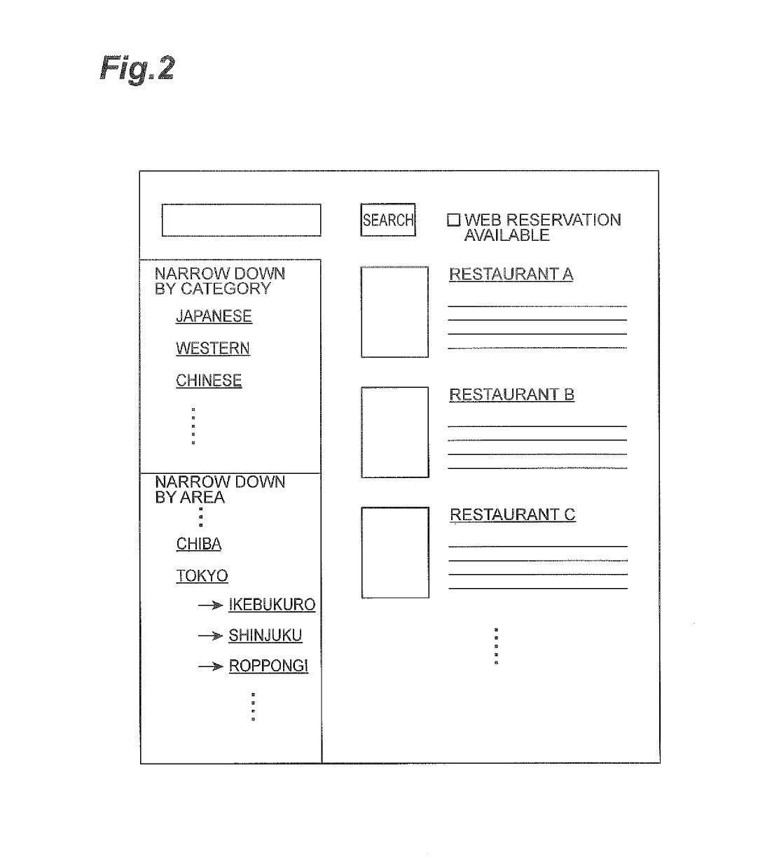

FIGS. 2 to 4 show the concept of reservation management in the reservation system 1. The reservation system 1 provides a restaurant search site (information providing means) to users. Through this site, users can search for a favorite restaurant and contact the restaurant for making a reservation.

The example of FIG. 2 shows a screen that contains conditions for narrowing down restaurants and a list of restaurants. This screen contains a text box and a search button for entering arbitrary words to search for restaurants, a checkbox for displaying only restaurants where reservations can be made, and links for narrowing down restaurants by category or area. Further, the screen displays a list of restaurants as an initial value or search result. Each restaurant name in the list is displayed as a link to a page showing the detailed information of the restaurant, and when a user clicks on the link, a detail page of the selected restaurant is displayed. In this specification, this detail page is referred to also as “restaurant page (facility page)”.

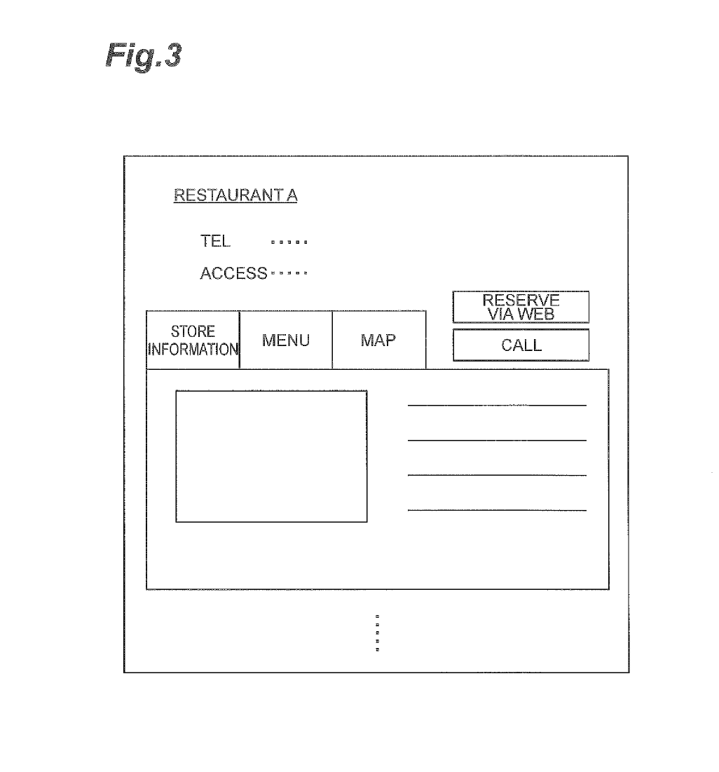

FIG. 3 shows an example of the restaurant page. A user accesses this detail page and can thereby know the telephone number, menu, map and the like of the selected restaurant. Further, a user can request a reservation for the restaurant by pressing “reserve via web” button. If the user terminal T has a call function, a user can make a call to the restaurant by pressing “call” button.

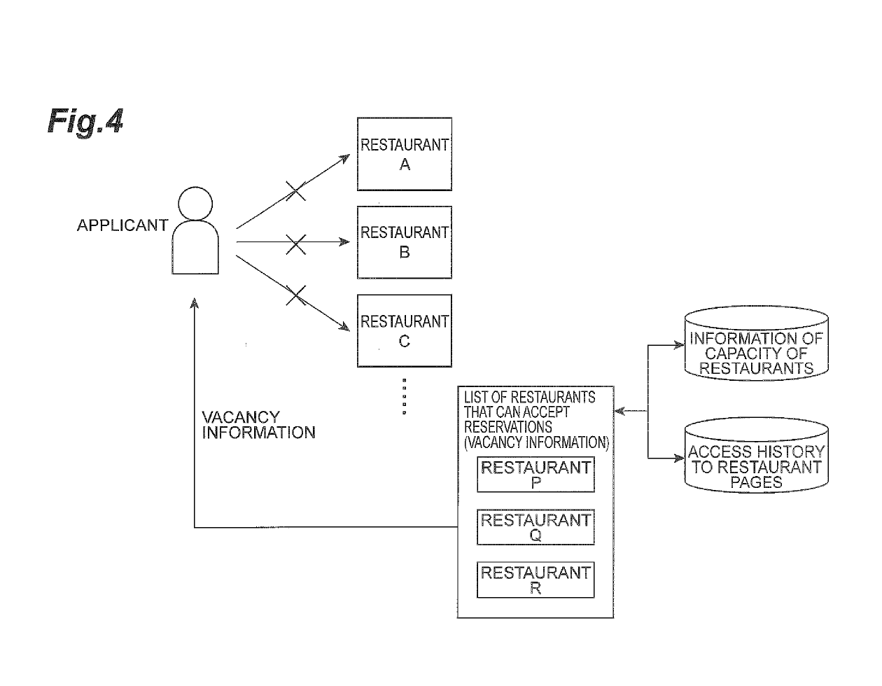

The reservation system 1 presents restaurants that can accept reservations to a user who has contacted some restaurants but failed to make reservations because they have been full with reservations. FIG. 4 is a view showing the outline of this feature.

In a web site according to related art that provides information of restaurants, a user cannot know availability of a restaurant to be reserved. Therefore, there are cases where, when a user tries to make a reservation for a certain restaurant, the restaurant is already full with reservations, and the user fails to make a reservation. In those cases, the user generally finds another restaurant in the web site and tries to make a reservation for the restaurant by call or via the web site. However, in some cases, the user contacts several restaurants but all of them are full with reservations, and the user cannot make any reservation. FIG. 4 shows that an applicant has tried to make reservations for restaurants A, B and C but failed.

When the situation where a user cannot make any reservation continues, the user may feel dissatisfied or give up making reservations. On the other hand, restaurants with vacancies lose an opportunity to gain customers.

In view of the above, when the situation where a user cannot make any reservation continues, the reservation system 1 presents, to an applicant, restaurants that are estimated to be able to accept reservations. To be specific, the reservation system I presents, to a user, restaurants that are estimated to have vacancies as vacancy information based on information indicating the capacity of each restaurant (capacity information) and a history of accesses to each restaurant page. In the example of FIG. 4, restaurants P, Q and R are presented to a user as restaurants that can accept reservations.

The capacity (seating capacity) of a restaurant is basic information of that facility, and it is not information to be updated by the restaurant each time a reservation is received. Further, the access history is information that is automatically accumulated in the reservation system 1, and it is not the one to be recorded by each restaurant. Thus, in this reservation system 1, it is not necessary for each restaurant to record or update the reservation status or availabilities in order to provide the vacancy information.

Databases in the database group 20 that are accessed by the reservation server 10 are described hereinbelow. The database group 20 is a group of various databases required in the reservation system 1. Each of the databases may be placed in any place, and the databases may be located together in one place or located in different places. The administrator of each database may be the same or different.

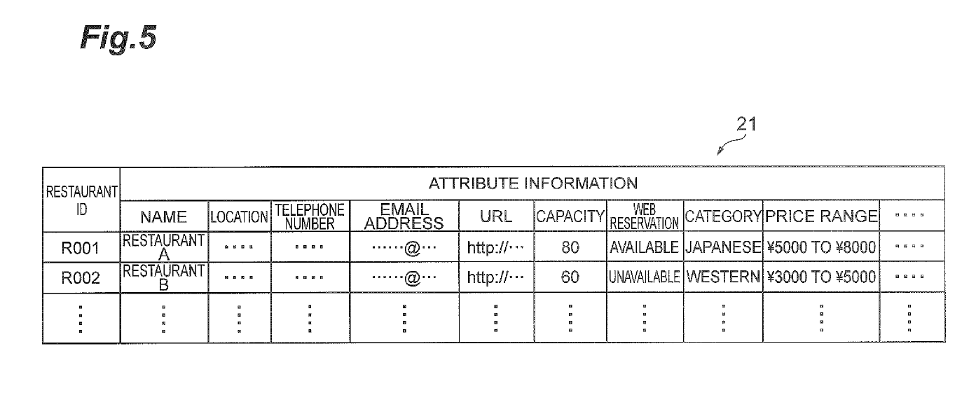

A restaurant database 21 is a device that stores information of each restaurant. This restaurant information (facility information) is basic information of restaurants as published in restaurant pages. As shown in FIG. 5, the restaurant information is a record in which restaurant ID that uniquely specifies a restaurant and attributes of the restaurant are associated. Although a name, a location, a telephone number, an email address, a restaurant page URL, capacity (seating capacity), availability of web reservations, a category, a price range and the like are shown as the items of restaurant attributes in the example of this figure, the items of attribute information are not limited thereto.

An access history database 22 is a device that stores access history of users to restaurants. Data recorded as the access history is not limited as long as it is data indicating that a user has accessed a restaurant in any way.

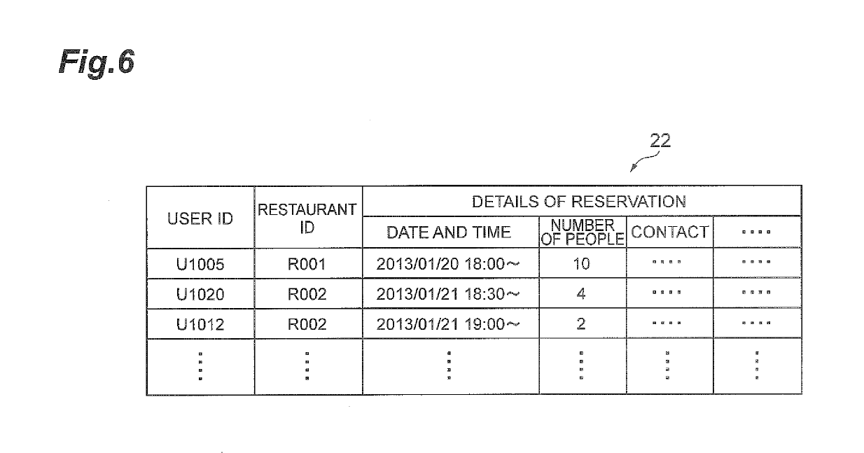

FIGS. 6 to 10 show examples of the access history. FIG. 6 is a view showing a reservation history indicating fixed reservations of restaurants. Because reservations for seats of restaurants are made when users access facilities using communication means such as telephone or web reservations, the reservation history is, in other words, an access history of users to restaurants. As shown in FIG. 6, the reservation history is a record in which user ID that uniquely specifies a user who has made a reservation, restaurant ID, and details of a reservation are associated. Although scheduled use date and time (reserved date and time), the number of people, contact of a person who has made a reservation and the like are shown as the details of a reservation in this example, the items of details of a reservation are not limited thereto. A record of the reservation history is deleted when a reservation is cancelled, a reserved use is done, or on a regular basis.

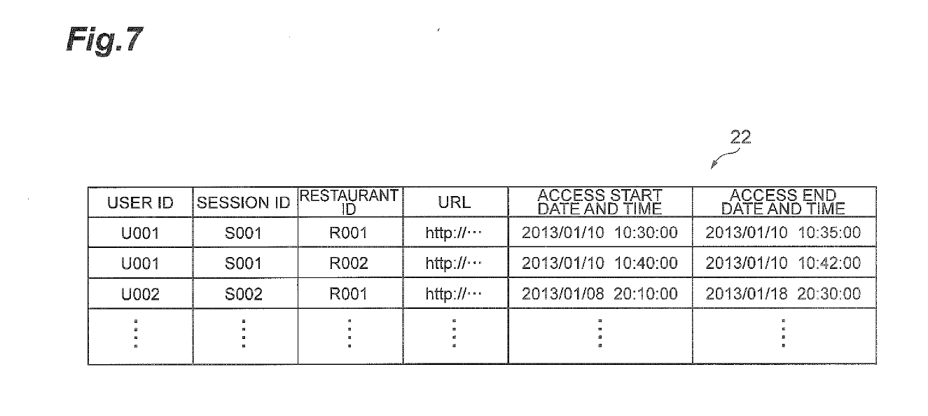

FIG. 7 shows a viewing history indicating that users have viewed restaurant pages. The viewing history is, stated differently, a record showing that restaurant pages are displayed on the user terminals T. Because the viewing of a web site means that a user has accessed a facility using the user terminal T, this viewing history is also the access history. As shown in FIG. 7, the viewing history is a record in which user ID, session ID that identifies HTTP session, restaurant ID, URL of an accessed restaurant page, and access start date and time and end date and time are associated. The example of FIG. 7 shows that a user “U001” has accessed two restaurant pages in one session “S001”. The viewing history may contain items other than the above. The restaurant ID is obtained by referring to the restaurant database 21 based on the accessed URL.

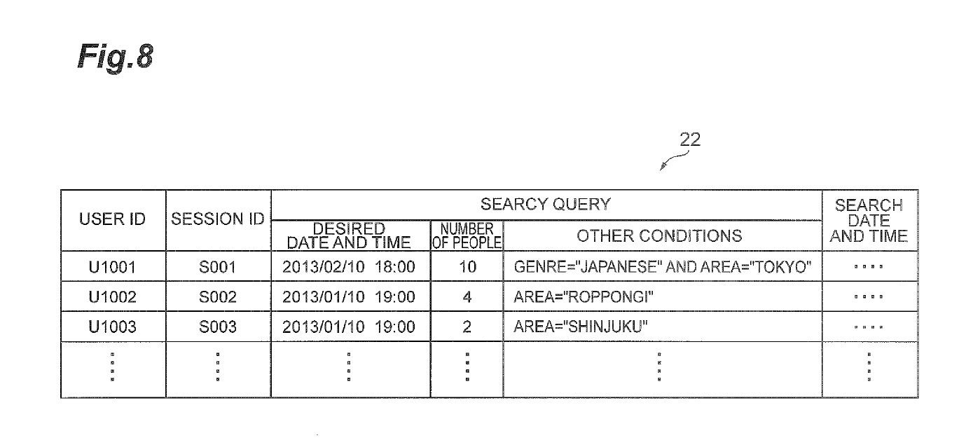

FIG. 8 shows an access history (search history) indicating search queries specified and transmitted in the user terminals T. In this example, a record in which user ID, session ID, query for product search, and search date and time are associated is accumulated as the access history. Each search query contains desired date and time for use and the number of prospective participants. In addition, each search query may contain other conditions such as the category of a restaurant, the area where a restaurant is located, and a price range.

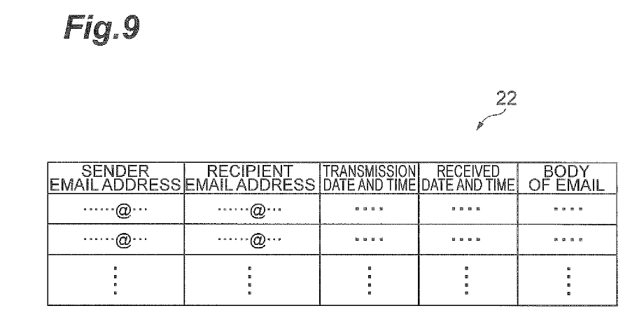

FIG. 9 shows a history of electronic mails (email history) transmitted between users and restaurants. The email history is one kind of record of communication (communication history) between users and restaurants. As shown in FIG. 9, the email history is a record in which sender email address, recipient email address, transmission date and time, received date and time, and the body of an email message are associated. The email history may contain items other than the above. The email history may be an actual email box managed by an email server, which is not shown, and in this case, the email box is a part or the whole of the access history database 22. Alternatively, the email history may be a copy of the email box.

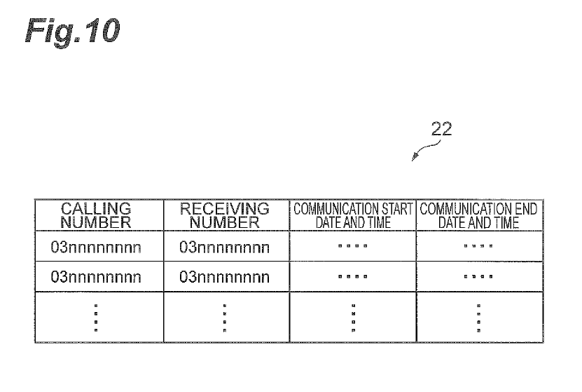

FIG. 10 shows a history of calls (call history) made between users and restaurants. This call history is also one kind of the communication history. As shown in FIG. 10, the call history is a record in which a calling number, a receiving number, call start date and time, and call end date and time are associated. The call history may contain items other than the above. The call history may be the call history of the user terminals T having a call function that is accumulated in a specified storage device. Alternatively, when one restaurant page is continuously displayed for a specified time period or longer (for example, 10 minutes or longer), the user terminal T, the reservation server 10, or another monitoring server may determine that a user has made a call to the restaurant, and generate the call history containing the telephone numbers of the user and the restaurant and store it into the access history database 22.

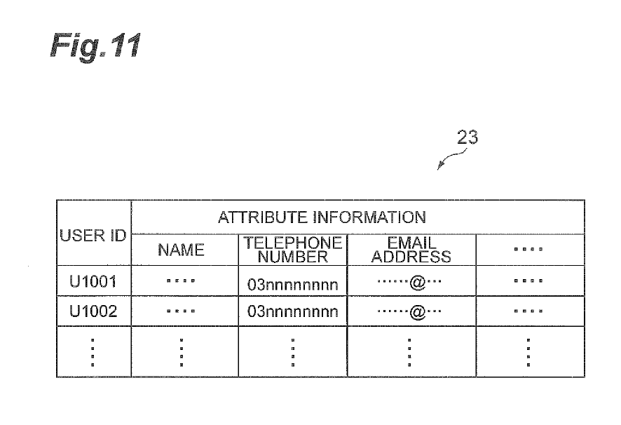

A user database 23 is a device that stores user information. As shown in FIG. 11, the user information is a record in which user ID and attributes are associated. Although a name, a telephone number, and an email address are shown as the items of the user attributes in the example of FIG. 11, the items of the attribute information are not limited thereto.

The structures of the above-described databases and records are not limited to those described above, and the databases may be normalized or made redundant by an arbitrary policy. For example, because ID of a restaurant and URL of its web site may have one-to-one correspondence, and one of those two items can be derived from the other one, restaurant ID may be omitted in the viewing history. Alternatively, user ID and restaurant ID may be added to the email history or the call history.

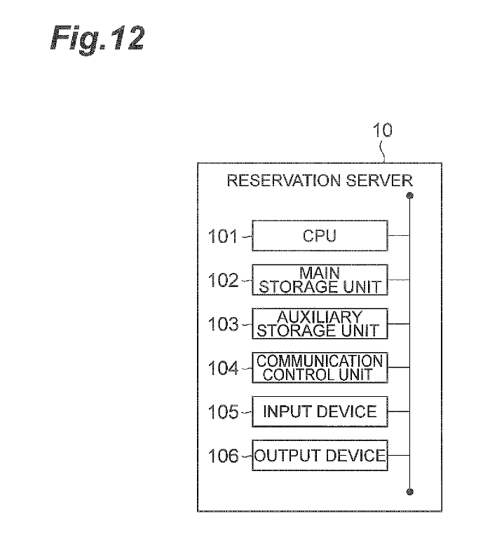

The reservation server 10 is described hereinafter. The hardware configuration of the reservation server 10 is as shown in FIG. 12. The reservation server 10 includes a CPU 101 that executes an operating system, an application program and the like, a main storage unit 102 such as ROM and RAM, an auxiliary storage unit 103 such as a hard disk or a flash memory, a communication control unit 104 such as a network card or a wireless communication module, an input device 105 such as a keyboard and a mouse, and an output device 106 such as a display.

The functional elements of the reservation server 10, which are described later, are implemented by loading given software onto the CPU 101 or the main storage unit 102, making the communication control unit 104, the input device 105, the output device 106 and the like operate under control of the CPU 101, and performing reading and writing of data in the main storage unit 102 or the auxiliary storage unit 103. The data and databases required for processing are stored in the main storage unit 102 or the auxiliary storage unit 103.

Although the reservation server 10 is composed of one computer in the example of FIG. 12, the reservation server 10 may be composed of a plurality of computers.

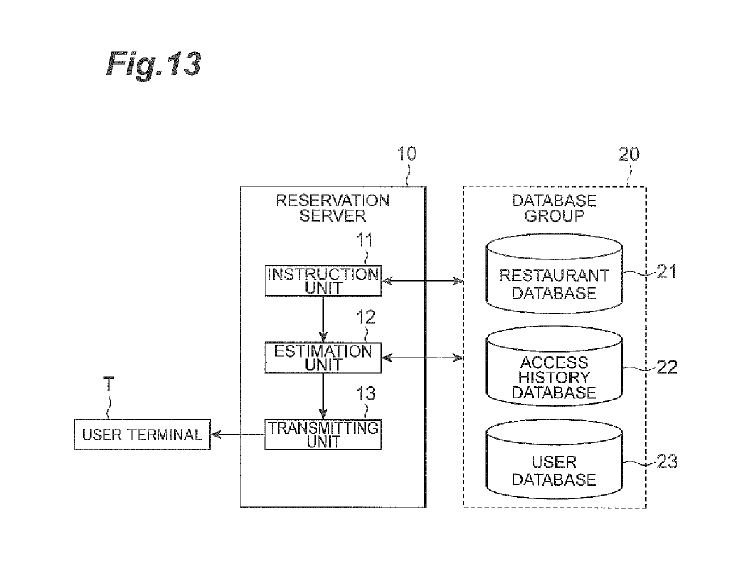

As shown in FIG. 13, the reservation server 10 includes, as functional elements, an instruction unit 11, an estimation unit (which serves also as an acquisition unit) 12, and a transmitting unit 13.

The instruction unit 11 is a functional element that determines whether it is necessary to provide the vacancy information to a user (applicant) and, when determining that it is necessary, instructs the creation of the vacancy information. The way of determining whether or not to create the vacancy information is not limited, and the instruction unit 11 may make determination by the following ways, for example. When it is determined that the creation of the vacancy information is necessary, the instruction unit 11 outputs an instruction signal to the estimation unit 12.

[Use of Viewing History] The instruction unit 11 may estimate the act of a user who is accessing a restaurant search site based on the viewing history and thereby determine whether or not to provide the vacancy information to the user. To be specific, when a user accesses a specified number or more of restaurant pages in one session, the instruction unit 11 provides the vacancy information to that user. A threshold THa that is used for this determination is not limited. For example, the threshold THa may be a given number between 2 to 10. The instruction unit 11 specifies a user who is accessing the threshold THa or more number of restaurant pages in the current session by referring to the access history database 22. Alternatively, when the stay time in the whole restaurant search site is a specified time period or more, the instruction unit 11 may determine to provide the vacancy information to the user.

When one or more users are specified, the instruction unit 11 specifies a search query used by each user. Specifically, the instruction unit 11 reads a search query corresponding to the user ID and the current session ID. The instruction unit 11 then generates one or more pairs of user ID and search query, and outputs the generated data as an instruction signal to the estimation unit 12. Note that, when a search query of the specified user is not acquired, the instruction unit 11 may set a search query of that user to NULL.

On the other hand, when no user is specified, the instruction unit 11 ends the processing without generating the instruction signal.

[Use of Email History] The instruction unit 11 may estimate the act of a user who is accessing a restaurant search site based on the email history and thereby determine whether or not to provide the vacancy information to the user. To be specific, the instruction unit 11 provides the vacancy information to a user who has received a notice indicating that a reservation is not accepted from a restaurant.

The instruction unit 11 refers to all the email history in the access history database 22 that has been generated during a past specified period from the current time and specifies an email that contains text indicating that a reservation cannot be accepted in its body. This email is referred to hereinafter as “reservation unaccepted notice”. The instruction unit 11 performs the specifying processing by text search with a preset keyword. The search range of the email history, which is, the length of the past period from the current time where the email history is to be referred to, may be set optionally. For example, the time interval may be any value from 10 minutes to 3 hours. Then, the instruction unit 11 refers to the user database 23 based on the sender or recipient address indicated by the specified email history and thereby specifies the user to whom the vacancy information is to be provided.

The instruction unit 11 specifies a user who has recently received a response that a reservation is not accepted at least once from a restaurant by using the email history. As another way, the instruction unit 11 may extract only users who have received a plurality of notices of unaccepted reservation. A threshold THb can be set optionally, and it may be set to any value between 2 to 5, for example.

When one or more users are specified, the instruction unit 11 refers to the search history and reads a search query corresponding to the user ID and the current session ID. The instruction unit 11 then generates one or more pairs of user ID and search query, and outputs the generated data as an instruction signal to the estimation unit 12. Note that, when a search query of the specified user is not acquired, the instruction unit 11 may set a search query of that user to NULL.

On the other hand, when no user is specified, the instruction unit 11 ends the processing without generating the instruction signal.

[Use of Call History] The instruction unit 11 may estimate the act of a user who is accessing a restaurant search site based on the call history and thereby determine whether or not to provide the vacancy information to the user. To be specific, the instruction unit 11 provides the vacancy information to a user who has called a plurality of restaurants during a past specified period from the current time.

The instruction unit 11 accesses the access history database 22 and refers to all records in the call history that have been generated during a past specified period from the current time, and thereby specifies a user who has called a plurality of restaurants during that period. A threshold TFIc for the number of restaurants that is used for this specifying work may be set optionally, and it may be set to any value between 2 to 5, for example. The search range of the call history, which is, the length of the past period from the current time where the call history is to be referred to, may be set optionally. For example, the time interval may be any value from 10 minutes to 3 hours. Then, the instruction unit 11 refers to the user database 23 based on the calling number or the receiving number indicated by the specified call history and thereby specifies the user to whom the vacancy information is to be provided.

When one or more users are specified, the instruction unit 11 refers to the search history and reads a search query corresponding to the user ID and the current session ID. The instruction unit 11 then generates one or more pairs of user ID and search query, and outputs the generated data as an instruction signal to the estimation unit 12. Note that, when a search query of the specified user is not acquired, the instruction unit 11 may set a search query of that user to NULL.

On the other hand, when no user is specified, the instruction unit 11 ends the processing without generating the instruction signal.

Unlike the email history, the call history does not contain the details of communication, and therefore it cannot be determined from the call history whether a reservation is made or not by the call. Thus, the instruction unit 11 specifies the user to whom the vacancy information is to be provided based on the assumption that a user who has called a plurality of restaurants is not likely to complete any reservation (is likely to receive a reservation unaccepted notice).

The estimation unit 12 is a functional element that estimates the availability of each restaurant and extracts restaurants that can accept reservations from an applicant based on the estimation result. The estimation unit 12 starts the extraction processing upon receiving the instruction signal.

As described above, the instruction signal contains one or more of pairs of user ID and search query. The estimation unit 12 performs search for restaurants that can accept reservations for each user. Hereinafter, the flow of the extraction processing for one user ID is described. The estimation unit 12 can extract restaurants with vacancies by various ways as described below.

[Use of Reservation History] The estimation unit 12 may extract restaurants with vacancies by calculating the number of vacant seats of each restaurant at desired date and time. To be specific, the estimation unit 12 refers to the reservation history and counts the number of people reserved for each restaurant at the desired date and time of a user. The estimation unit 12 then calculates the number of vacant seats of each restaurant by the following equation. The capacity can be obtained from restaurant information.

(number of vacant seats)=(capacity)−(total number of people reserved)

For example, when the capacity of a restaurant A is 80 (people), a restaurant A has reservations R1, R2 and R3 at the desired date and time of a user, and the number of people in each reservation is 10, 4 and 2, respectively, the number of vacant seats is 80−(10+4+2)=64.

In the case where reservations for restaurants can be made also through reservation systems other than the reservation system 1, the number of vacant seats in a restaurant can be smaller than the value obtained by the above equation. Thus, the estimation unit 12 may multiply the number of people reserved obtained from the reservation history in the access history database 22 by a coefficient α, where α>1, and calculate the number of vacant seats. The way of determining the coefficient α is optional. For example, the coefficient α may be determined based on the number of other web sites, the number of accesses to each website, or the like.

For example, when α=3 in the above-described example about the restaurant A, the estimated number of vacant seats is 80−3×(10+4+2)=32.

After calculating the number of vacant seats of each restaurant, the estimation unit 12 associates “reservation acceptable flag=ON” with restaurants where the number of vacant seats is a specified threshold THd or more, and associates “reservation acceptable flag=OFF” with restaurants where the number of vacant seats is less than the threshold THd. The threshold THd may be the number of peoples specified in a search query of a user, or it may be a fixed value (for example, any value between 2 to 10). The threshold THd may be different depending on restaurants or attributes (genre, area, price range etc.) of restaurants. Use of the number of people specified in a search query allows extraction of restaurants that match the user's requirements. On the other hand, use of the fixed value allows narrowing down restaurants even when the number of people is not specified in a search query.

When another condition such as a category or an area is specified in a search query, the estimation unit 12 associates “match flag=ON” with restaurants where the reservation acceptable flag is ON and which satisfy that condition, and associates “match flag=OFF” with restaurants which do not satisfy that condition. When, on the other hand, another condition is not specified, the estimation unit 12 sets the match flag to ON for all restaurants.

Then, the estimation unit 12 outputs a list of the restaurants extracted finally and the number of vacant seats calculated for each restaurant to the transmitting unit 13.

[Use of Viewing History] When the reservation history of a restaurant cannot be acquired, the estimation unit 12 may determine whether the restaurant can accept reservations or not based on the viewing history of a web page of that restaurant. To be specific, the estimation unit 12 counts, for each restaurant, the viewing history that has been generated during a past specified period from the current time and thereby obtains the number of accesses to each restaurant page. The specified period may be set optionally, and it may be one day, one week or one month, for example. In general, restaurants have on-season and off-season, and the specified period may be varied according to the season. Then, the estimation unit 12 divides, for each restaurant, the number of accesses by the capacity of the restaurant and obtains the result as an access rate. In other words, the access rate is calculated by the following equation in this specification.

(access rate)=(number of accesses)/(capacity)

For example, when the capacity of a restaurant A is 80 (people), and the counted number of accesses to the web page of the restaurant A is 120, the access rate is 120/80=1.5.

After calculating the access rate of each restaurant in this manner, the estimation unit 12 associates “reservation acceptable flag=ON” with restaurants where the access rate is less than a specified threshold THe, and associates “reservation acceptable flag=OFF” with restaurants where the access rate is the threshold THe or more. The way of setting the threshold THe is not limited. For example, the threshold THe may be set after estimating a typical ratio of the number of requested reservations to the number of accesses. In this case, because it is not likely that all of accessed users request reservations, the threshold THe may be set to a value larger than 1 (for example, any value between 2 to 10). By using the viewing history in this manner, it is possible to estimate the availability of restaurants even when the number of seat reservations cannot be specified. The threshold THe may be different depending on restaurants or attributes (genre, area, price range etc.) of restaurants.

When another condition such as a category or an area is specified in a search query, the estimation unit 12 associates “match flag=ON” with restaurants where the reservation acceptable flag is ON and which satisfy that condition, and associates “match flag=OFF” with restaurants which do not satisfy that condition. When, on the other hand, another condition is not specified, the estimation unit 12 sets the match flag to ON for all restaurants.

Then, the estimation unit 12 outputs a list of the restaurants extracted finally. At this time, the estimation unit 12 may estimate the number of seat reservations from the number of accesses to each restaurant, and output a value obtained by subtracting the number of seat reservations from the capacity as the number of vacant seats to the transmitting unit 13. For example, it is assumed that reservations are made at a rate of one to eight in the restaurant A, and when the number of accesses is 120, the estimation unit 12 estimates the number of seat reservations as 120/8=15, and estimates the number of vacant seats as 80−15=65.

When the number of restaurants where the reservation acceptable flag and the match flag are both ON is a specified number or less, the estimation unit 12 may perform the same estimation processing again with a less strict condition than the estimation processing performed last time.

For example, the estimation unit 12 may increase the number of restaurants to be presented to a user as restaurants that can accept reservations by relaxing the condition for setting the match flag to ON. A means of relaxing the condition is extending or changing the area of restaurants, increasing or changing the price range or the like. If a user makes search a plurality of times in one session, the estimation unit 12 may set the match flag of the restaurant that matches at least one of a plurality of search queries to ON.

Alternatively, the estimation unit 12 may increase the number of restaurants to be presented to a user as restaurants that can accept reservations by relaxing the condition for setting the reservation acceptable flag to ON. For example, the estimation unit 12 may perform the same estimation processing again with a smaller value of the threshold THd or a larger value of the threshold THe than before.

The estimation unit 12 generates a list of restaurants that can accept reservations for each user ID and outputs it to the transmitting unit 13. In this processing, in order to transmit basic information of each restaurant also to the user terminal T, the estimation unit 12 extracts that information from the restaurant database 21 and adds it to the list.

The transmitting unit 13 is a functional element that transmits vacancy information (information based on the estimation result) indicating extracted restaurants, which are restaurants estimated to be able to accept reservations, to the user terminal T. The transmitting unit 13 transmits the input list as the vacancy information to the user terminal T corresponding to the user ID. When presenting the vacancy information to a plurality of users, the transmitting unit 13 transmits the corresponding vacancy information to the terminal T of each user.

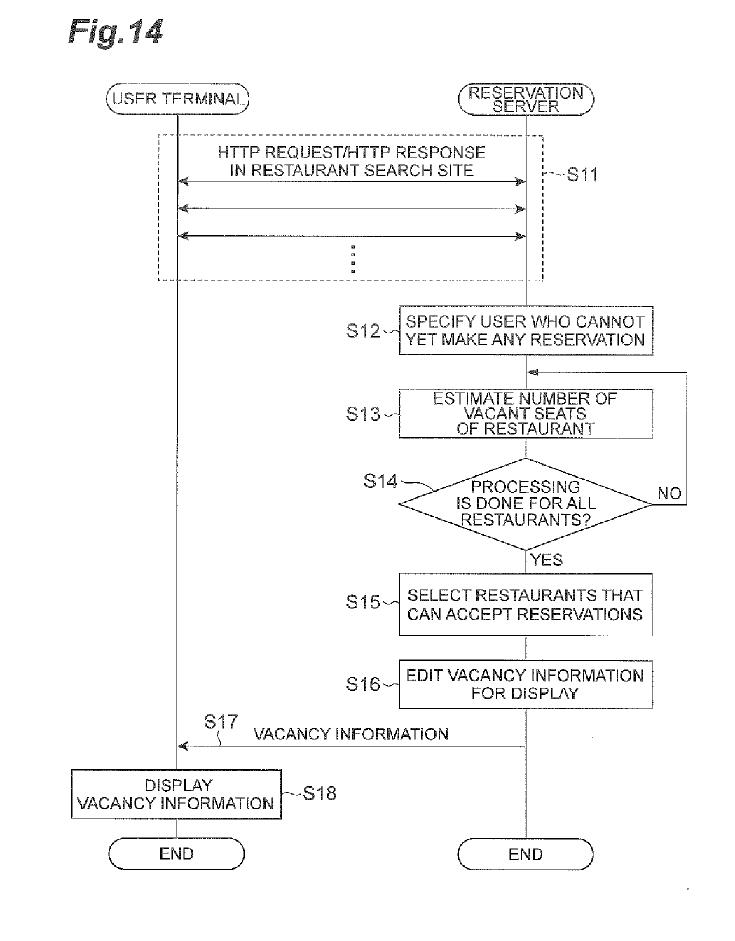

The operation of the reservation system 1 is described, and further an information processing method according to this embodiment is described hereinafter with reference to FIG. 14. Hereinafter, based on the assumption that a user accesses a restaurant search site with the user terminal T and searches for restaurants, views each restaurant page or tries to make a web reservation but cannot make a reservation, the processing after that is described. In this case, HTTP request/HTTP response has been generated several times between the user terminal T and the reservation server 10 in the restaurant search site (Step S11).

At this time, in the reservation server 10, the instruction unit 11 specifies a user who cannot yet make any reservation and gives an instruction to generate a list of restaurants that can accept reservations for that user, to the estimation unit 12 (Step S12). As described earlier, the instruction unit 11 can specify such a user based on the viewing history, the email history or the call history.

Next, the estimation unit 12 estimates the number of vacant seats of each restaurant (Step S13). As described earlier, the estimation unit 12 can determine the number of vacant seats based on the reservation history or the viewing history. After estimating the number of vacant seats of all restaurants (YES in Step S14), the estimation unit 12 selects the restaurants that can accept reservations (Step S15). This selection can be made in various ways as described earlier. Those steps S13 to S15 correspond to the acquisition step and the estimation step.

Then, the transmitting unit 13 edits the vacancy information (for example, sorting as described below) for display if necessary (Step S16), and transmits the vacancy information to the user terminal T (Step S17, transmitting step).

The user terminal T receives the vacancy information and displays it on the screen (S18). The restaurants that can accept reservations are thereby displayed on the screen together with the number of vacant seats, and therefore the user can contact a restaurant that would be able to accept reservations based on the vacancy information.

The user terminal T may display the vacancy information in various ways as described below.

For example, the user terminal T may display a list that contains only the restaurants determined to be able to accept reservations. In this case, the user terminal T displays only the restaurants where the reservation acceptable flag is ON.

Alternatively, the user terminal T may display the restaurants in descending order of the number of vacant seats or in ascending order of the access rate in order to preferentially display the restaurants for which reservations can be easily made. Further, the user terminal T may display only the restaurants ranked high (for example, only the top ten restaurants).

Alternatively, the user terminal T may display the restaurants in descending order of the degree of matching with a search query specified by an applicant. In this case, the user terminal T displays the restaurants where both of the reservation acceptable flag and the match flag are ON in preference to other restaurants.

Alternatively, the user terminal T may display the restaurants in descending order of distance from the current position of the user terminal T. In this case, the user terminal T finds the current position of its terminal by GPS (Global Positioning System) function or the like and compares the current position with each restaurant information (location) and thereby sort the restaurant information in the list.

Alternatively, the user terminal T may display a list that contains both of the restaurants determined to be able to accept reservations and the restaurants determined to be unable to accept reservations. In this case, the user terminal T sets the order of display so that the restaurants where the reservation acceptable flag is ON are ranked higher than the restaurants where the reservation acceptable flag is OFF. In this case also, the user terminal T may arrange the restaurants in descending order of the number of vacant seats or in ascending order of the access rate.

Alternatively, the user terminal T may highlight only the restaurants determined to be able to accept reservations without highlighting the restaurants determined to be unable to accept reservations. The way of highlighting is not limited, and various ways such as changing the background color, placing a mark or making pop-up display can be used, for example.

Alternatively, the user terminal T may preferentially display the restaurants that has been unable to accept reservations at the time when a user has accessed before but that is now able to accept reservations because a vacancy arises after that. In this case, the estimation unit 12 or the transmitting unit 13 in the reservation server 10 records the history of vacancy information in a specified database (not shown). Then, the estimation unit 12 compares the vacancy information generated this time with the vacancy information generated in the past, and adds information indicating that it has become able to accept reservations only to the restaurant where the reservation acceptable flag has changed from OFF to ON.

When displaying the vacancy information, the user terminal T may switch the display on the screen from the current page to the vacancy information page, or may pop-up display the vacancy information with the current page left. At this time, before page switching or pop-up display, the user terminal T may make an inquiry to a user by displaying a message about whether the control of such control is allowable, and may perform page switching or pop-up display only after receiving from the user the input indicating that it is allowable.

Although there are various ways of displaying the vacancy information as described above, because the vacancy information is displayed in the way appealing to an applicant in any case, and the applicant can easily find the restaurants where reservations can be made.

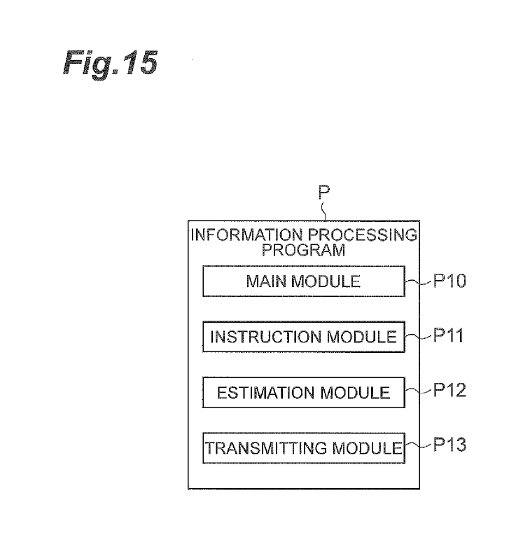

An information processing program P that causes a computer to function as the reservation server 10 is described hereinafter with reference to FIG. 15.

The information processing program P includes a main module P10, an instruction module P11, an estimation module P12, and a transmitting module P13.

The main module P10 is a part that exercises control over reservation management. The functions implemented by executing the instruction module P11, the estimation module P12 and the transmitting module P13 are equal to the functions of the instruction unit 11, the estimation unit 12 and the transmitting unit 13 described above, respectively.

The information processing program P may be provided in the form of being recorded in a static manner on a tangible recording medium such as CD-ROM or DVD-ROM or semiconductor memory, for example. Further, the information processing program may be provided as a data signal superimposed onto a carrier wave through a communication network.

As described above, according to this embodiment, the availability of each restaurant is estimated from the capacity information of the restaurant and the access history to the restaurant, and restaurants that can accept reservations from a user are extracted based on the estimation result and provided to the user. In this manner, by estimating the availability of restaurants from the access status to restaurants, it is possible to save each restaurant time and effort to record or update its availability by themselves. It is thereby possible to receive reservations for restaurants from users while reducing a burden on restaurants that manage vacancies.

Further, according to this embodiment, an applicant who cannot yet make any reservation is estimated based on the user's viewing history, viewing history or call history, and the vacancy information is presented to the applicant. It is thereby possible to avoid the situation where a user gives up making a reservation, and restaurants with vacancies can have an opportunity to gain customers. In this manner, the reservation system 1 is convenient both for users and restaurants.

An embodiment of the present invention is described in detail above. However, the present invention is not limited to the above-described embodiment. Various changes and modifications may be made to the present invention without departing from the scope of the invention.

The control of display of the vacancy information in the user terminal T may be performed by the reservation server 10, the user terminal T, or both of them in cooperation.

When displaying the vacancy information, the number of vacant seats may be omitted.

The instruction unit 11 may output the instruction signal when a signal requesting vacancy information is received from the user terminal T. The request signal at least contains a user ID, and may further contain a search query for narrowing down restaurants. In this case, the instruction unit 11 outputs the user ID or a pair of the user ID and the search query as the instruction signal to the estimation unit 12. Note that, when the request signal does not contain a search query, the instruction unit 11 may acquire a search query from the search history of the access history database 22. Specifically, the instruction unit 11 may read the search query corresponding to the user ID and the latest session ID and add the search query to the instruction signal.

### REFERENCE SIGNS LIST

1 . . . reservation system, 10 . . . reservation server (information processing device), 11 . . . instruction unit, 12 . . . estimation unit (serving also as an acquisition unit), 13 . . . transmitting unit, 20 . . . database group (storage unit), 21 . . . restaurant database, 22 . . . access history database, 23 . . . user database, P . . . information processing program, P10 . . . main module, P11 . . . Instruction module, P12 . . . estimation module, P13 . . . transmitting module, T . . . user terminal

1. An information processing device comprising:
at least one memory operable to store computer program code;
at least one processor operable to access said memory, read said program code, and operate according to said program code, said program code including:
instruction code configured to cause at least one of said at least one processor to determine to provide an applicant with information based on an estimation result of whether or not a target facility can accept a reservation when it is determined, based on an access history indicating that the applicant has accessed a facility, that the applicant has accessed a plurality of facility pages within a specified period of time, or when it is determined based on the access history that the applicant has received a reservation unaccepted notice from a plurality of facilities by emails or calls;
estimation code configured to cause at least one of said at least one processor to estimate whether the target facility can accept a reservation based on seating capacity of the target facility and the number of accesses to the target facility during a past specified period from the current time, when the instruction unit determines to provide the applicant with the information; and
transmitting code configured to cause at least one of said at least one processor to output the information based on an estimation result to the user terminal of the applicant.

2. The information processing device according to claim 1, wherein
the estimation code is configured to cause at least one of said at least one processor to acquire a total number of people for reservations made between the target facility and users, calculate the number of vacant seats of the target facility from the seating capacity and the total number multiplied by a specified coefficient larger than 1, and estimate that the target facility can accept a reservation when the number of vacant seats is equal to or larger than a specified threshold.

3. The information processing device according to claim 1, wherein
the estimation code is configured to cause at least one of said at least one processor to acquire an access rate by dividing the number of accesses to a facility page of the target facility by the seating capacity, and estimate that the target facility can accept a reservation when the access rate is equal to or lower than a specified threshold.

4. The information processing device according to claim 2, wherein
when the at least on processor controlled by said estimation code can acquire the total number, the estimation code causes the at least one processor to calculate the number of vacant seats and estimate that the target facility can accept a reservation when the number of vacant seats is equal to or larger than a specified threshold, and
when the at least one processor controlled by the estimation code cannot acquire the total number, the estimation code causes said at least one processor to acquire an access rate by dividing the number of accesses to a facility page of the target facility by the seating capacity, and estimate that the target facility can accept a reservation when the access rate is equal to or lower than a specified threshold.

5. (canceled)

6. The information processing device according to claim 1, wherein
the access history contains a viewing history being records of viewing of the facility pages by the applicant, and
the instruction code is configured to cause at least one of said at least one processor to determine to provide the applicant with the information when it is determined based on the viewing history that the applicant has accessed the plurality of facility pages within the specified period of time.

7. (canceled)

8. The information processing device according to claim 1, wherein
the access history includes an email history being records of emails between the applicant and the facilities, and
the instruction code is configured to cause at least one of said at least one processor to analyze content of each email and thereby determine—whether the email corresponds to the reservation unaccepted notice.

9. The information processing device according to claim 1, wherein
the access history includes a call history being records of calls between the applicant and the facilities, and
the instruction code is configured to cause at least one of said at least one processor to determine that the applicant has received the reservation unaccepted notice from a plurality of the facilities when it is specified based on the call history that the applicant has called the plurality of facilities within a specified period of time.

10. The information processing device according to claim 1, wherein
when the number of target facilities able to accept reservations obtained by estimation processing is equal to or less than a specified number, the estimation code causes at least one of said at least one processor to perform another estimation processing with a less strict condition than the estimation processing.

11. An information processing method executed by an information processing device having a processor, the method comprising:
determining to provide an applicant with information based on an estimation result of whether or not a target facility can accept a reservation when it is determined, based on an access history indicating that the applicant has accessed a facility, that the applicant has accessed a plurality of facility pages within a specified period of time, or when it is determined based on the access history that the applicant has received a reservation unaccepted notice from a plurality of facilities by emails or calls;
estimating whether the target facility can accept a reservation based on seating capacity of the target facility and the number of accesses to the target facility during a past specified period from the current time, when it is determined that the information is to be provided to the applicant; and
outputting the information based on an estimation result to the user terminal of the applicant.

12. A non-transitory recording medium storing an information processing program causing a computer to:
determine to provide an applicant with information based on an estimation result of whether or not a target facility can accept a reservation when it is determined, based on an access history indicating that the applicant has accessed a facility, that the applicant has accessed a plurality of facility pages within a specified period of time, or when it is determined based on the access history that the applicant has received a reservation unaccepted notice from a plurality of facilities by emails or calls;
estimate whether the target facility can accept a reservation based on seating capacity of the target facility and the number of accesses to the target facility during a past specified period from the current time, when it has been determined to provide the applicant with the information; and
output the information based on an estimation result to the user terminal of the applicant.
